(19) United States
(12) Patent Application Publication
(10) Pub. No.: US 2004/0257981 A1
(43) Pub. Date: Dec. 23, 2004

(54) Apparatus and method for transmitting and receiving pilot patterns for identifying base stations in an OFDM communication system

(75) Inventors: Jung-Min Ro, Seoul (KR); Seok-Hyun Yoon, Seoul (KR); Seong-Iii Park, Seongnam-si (KR); Young-Kwon Cho, Suwon-si (KR); Young-Kyun Kim, Seongnam-si (KR); Hyeon-Woo Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/872,111

(22) Filed: Jun. 18, 2004

(30) Foreign Application Priority Data
Jun. 18, 2003 (KR) 39590/2003

(51) Int. Cl. H04J 11/00

(52) U.S. Cl. 370/210; 370/203

(57) ABSTRACT

A pilot pattern set time interval of an OFDM communication system is divided into a plurality of sub-time intervals. Pilot patterns are generated considering a coherence bandwidth and a coherence time for each of the sub-time intervals, and pilot pattern sets are generated by combining the pilot patterns generated for each sub-time interval. Base stations included in the OFDM communication system are identified with the pilot pattern sets, thereby increasing the number of base stations that can be identified. Therefore, the limited radio resources, i.e., the limited pilot pattern resources, are grouped for efficient utilization, thereby contributing to improvement in system performance.

### PRIORITY

This application claims priority under 35 U.S.C. § 119 to an application entitled “Apparatus and Method for Transmitting/Receiving Pilot Pattern for Identification of Base Station in an OFDM Communication System” filed in the Korean Intellectual Property Office on Jun. 18, 2003 and assigned Serial No. 2003-39590, the contents of which are incorporated herein by reference.

### BACKGROUND OF THE INVENTION

1. Field of the Invention

The present invention relates generally to a communication system utilizing an Orthogonal Frequency Division Multiplexing (OFDM) scheme, and in particular, to an apparatus and method for generating, transmitting, and receiving a pilot pattern for identifying a base station.

2. Description of the Related Art

In an Orthogonal Frequency Division Multiplexing (OFDM) scheme used for high-speed data transmission over wire/wireless channels, data is transmitted using multiple carriers. The OFDM scheme is a type of a Multi-Carrier Modulation (MCM) scheme for parallel-converting of a serial input symbol stream and modulating the parallel-converted symbols with multiple sub-carriers, or multiple sub-channels.

In a transmitter for a communication system utilizing the OFDM scheme (hereinafter referred to as an “OFDM communication system”), input data is modulated with sub-carriers through a scrambler, an encoder, and an interleaver. The transmitter provides a variable data rate, and has different coding rate, interleaving size, and modulation scheme according to the data rate. Commonly, the encoder uses a coding rate of ½ or ¾. An interleaver size for preventing a burst error is determined according to the number of coded bits per OFDM symbol (NCBPS). Quadrature phase shift keying (QPSK), 8-ary phase shift keying (8PSK), 16-ary quadrature amplitude modulation (16 QAM), and 64 QAM schemes can be used as the modulation scheme, according to a data rate.

A predetermined number of pilot sub-carriers are added to a signal modulated with a predetermined number of sub-carriers by the above-described elements, and then generated into an OFDM symbol through an inverse fast Fourier transform (IFFT) unit. Frequency-domain symbols become time domain symbols after IFFT process. In the IFFT unit, a guard interval for removing inter-symbol interference in a multi-path channel environment is inserted into the OFDM symbol, and the guard interval-inserted OFDM symbol is finally input to a radio frequency (RF) processor. The RF processor converts the input signal into an RF signal and transmits the RF signal over the air.

In a receiver for the OFDM communication system, a reverse process for the process performed in the transmitter is performed, and a synchronization process is added thereto. The receiver estimates a frequency offset and a symbol offset using a training symbol previously set for a received OFDM symbol. Thereafter, a guard interval-removed data symbol is demodulated with a plurality of sub-carriers to which a plurality of pilot sub-carriers are added, through a fast Fourier transform (FFT) unit. Further, in order to cope with path delay on an actual radio channel, an equalizer estimates a channel condition for a received channel signal and removes signal distortion on the actual radio channel from the received channel signal. Data that was channel-estimated through the equalizer is converted into a bit stream, and then input to a de-interleaver. Thereafter, the de-interleaved bit stream is output as final data through a decoder and a de-scrambler for error correction.

As described above, in the OFDM communication system, a transmitter, or a base station (BS), transmits pilot sub-carrier signals to a receiver, or a mobile station (MS). The base station transmits data sub-carrier signals (hereinafter referred to as “data channel signals”) together with the pilot sub-carrier signals. The pilot sub-carrier signals are transmitted for synchronization acquisition, channel estimation, and base station identification. The pilot sub-carrier signals serve as a type of a training sequence, and are used for channel estimation between a transmitter and a receiver. Further, mobile stations can identify their base stations using the pilot sub-carrier signals. Points where the pilot sub-carrier signals are transmitted have been previously agreed between the transmitter and the receiver. As a result, the pilot sub-carrier signals also serve as a type of reference signals.

A base station transmits the pilot sub-carrier signals such that the pilot sub-carrier signals can travel to a cell boundary with relatively high transmission power, compared with the data channel signals, while having a particular pattern, or a pilot pattern. The base station the pilot sub-carrier signals are transmitted such that they can reach up to the cell boundary while having a particular pilot pattern because a mobile station, when it enters a cell, has no information on its current base station. In order to detect its base station, the mobile station must use the pilot sub-carrier signals. Therefore, the base station transmits the pilot sub-carrier signals in a particular pilot pattern with relatively high transmission power so that the mobile station can detect its base station.

The pilot pattern is generated by pilot sub-carrier signals transmitted by the base station. That is, the pilot pattern is based on a slope of the pilot sub-carrier signals and a transmission start point of the pilot sub-carrier signals. Accordingly, the OFDM scheme should be designed such that base stations have their own unique pilot patterns for their identification. In addition, the pilot pattern is considered a coherence bandwidth and a coherence time.

The coherence bandwidth represents a maximum bandwidth where it can be assumed that a channel is constant, in a frequency domain. The coherence time represents a maximum time period where it can be assumed that a channel is constant, in a time domain. Because it can be assumed that a channel is constant within the coherence bandwidth and coherence time, even though only one pilot sub-carrier signal is transmitted for the coherence bandwidth and coherence time, it is sufficient for synchronization acquisition, channel estimation, and base station identification. As a result, it is possible to maximize transmission of data channel signals.

In conclusion, a maximum frequency interval for transmitting pilot sub-carrier signals is a coherence bandwidth, and a maximum time interval, or a maximum OFDM symbol time interval, for transmitting the pilot sub-carrier signals is a coherence time.

The number of base stations included the OFDM communication system is variable, and the number of the base stations increases, as a size of the OFDM communication system increases. Therefore, in order to identify all the base stations, the number of pilot patterns having different slopes and different start points should be identical to the number of the base stations. However, in the OFDM communication system, in order to transmit a pilot sub-carrier signal in a time-frequency domain, the coherence bandwidth and the coherence time should be considered, and when the coherence bandwidth and the coherence time are considered, the pilot patterns having different slopes and different start points are restrictively generated.

When pilot patterns are generated without considering the coherence bandwidth and the coherence time, pilot sub-carrier signals in the pilot patterns representing different base stations coexist. In this case, it is not possible to identify a base station using the pilot patterns.

FIG. 1 is a diagram schematically illustrating points where pilot sub-carrier signals based on a pilot pattern are transmitted in a conventional OFDM communication system using one pilot channel. However, before a description of FIG. 1 is given, it is assumed that circles illustrated in FIG. 1 represent points where pilot sub-carrier signals are actually transmitted, and transmission points of the pilot sub-carrier signals are expressed in the form of (time domain, frequency domain).

Referring to FIG. 1, a first pilot sub-carrier signal is transmitted at a (1,1) point 101, a second pilot sub-carrier signal is transmitted at a (2,4) point 102, a third pilot sub-carrier signal is transmitted at a (3,7) point 103, a fourth pilot sub-carrier signal is transmitted at a (4,10) point 104, a fifth pilot sub-carrier signal is transmitted at a (5,2) point 105, a sixth pilot sub-carrier signal is transmitted at a (6,5) point 106, a seventh pilot sub-carrier signal is transmitted at a (7,8) point 107, and an eighth pilot sub-carrier signal is transmitted at a point (8,11) 108. It is assumed in FIG. 1 that 8 OFDM symbols constitute one OFDM frame, and 8 pilot sub-carrier signals constitute one pilot pattern.

In the pilot pattern illustrated in FIG. 1, the start point is (1,1) 101 and the slope is 3. That is, a pilot sub-carrier signal is transmitted at the (1,1) point 101, and thereafter, the other pilot sub-carrier signals are transmitted with a slope of 3. In addition, pilot channel based on a pilot pattern transmitted in the time-frequency domain are represented by Equation (1).

σₛ(j,t)=st+nⱼ(mod N), for j=1, . . . , Nₚ (1)

In Equation (1), σₛ(j,t) denotes a transmission point of a j^{th} pilot channel having a slope ‘s’ at a time t, nⱼ is a frequency offset and denotes a point where a first pilot sub-carrier signal is separated from the origin of the time-frequency domain, N denotes the total number of sub-carriers of the OFDM communication system, and Nₚ denotes the number of pilot channels. Here, the number Nₚ of pilot channels is previously determined in the OFDM communication system, and known to both a transmitter and a receiver.

As a result, for the pilot pattern illustrated in FIG. 1, a slope ‘s’ is 3 (s=3), a frequency offset nⱼ is 0 (nⱼ=0), the total number N of sub-carriers of the OFDM communication system is 11 (N=11), and the number Nₚ of pilot channels is 1 (Nₚ=1).

FIG. 2 is a diagram schematically illustrating points where pilot sub-carrier signals based on a pilot pattern are transmitted in a conventional OFDM communication system using two pilot channels. However, before a description of FIG. 2 is given, it is assumed that circles illustrated in FIG. 2 represent points where pilot sub-carrier signals are actually transmitted, and transmission points of the pilot sub-carrier signals are expressed in the form of (time domain, frequency domain). Further, it is assumed in FIG. 2 that a coherence bandwidth 201 corresponds to 6 sub-carriers, and a coherence time 202 is 1 in a time domain, i.e., the coherence time 202 is one OFDM symbol. Because the coherence bandwidth 201 corresponds to 6 sub-carriers and the coherence time 202 is one OFDM symbol, a pilot sub-carrier signal must be separated by a bandwidth corresponding to a maximum of 6 sub-carriers and transmitted for at least one OFDM symbol in order to reflect its channel condition. Alternatively, a plurality of pilot sub-carrier signals can be transmitted within the coherence bandwidth 201. In this case, however, less data channel signals are transmitted due to transmission of the pilot sub-carrier signals, resulting in a decrease in data rate. Therefore, in FIG. 2, only one pilot sub-carrier signal is transmitted within the coherence bandwidth 201.

FIG. 2 illustrates two pilot channels: a first pilot channel and a second pilot channel. For the first pilot channel, a first pilot sub-carrier signal is transmitted at a (1,1) point 211, a second pilot sub-carrier signal is transmitted at a (2,4) point 212, a third pilot sub-carrier signal is transmitted at a (3,7) point 213, a fourth pilot sub-carrier signal is transmitted at a (4,10) point 214, a fifth pilot sub-carrier signal is transmitted at a (5,2) point 215, a sixth pilot sub-carrier signal is transmitted at a (6,5) point 216, a seventh pilot sub-carrier signal is transmitted at a (7,8) point 217, and an eighth pilot sub-carrier signal is transmitted at a point (8,11) 218. For the second pilot channel, a first pilot sub-carrier signal is transmitted at a (1,7) point 221, a second pilot sub-carrier signal is transmitted at a (2,10) point 222, a third pilot sub-carrier signal is transmitted at a (3,2) point 223, a fourth pilot sub-carrier signal is transmitted at a (4,5) point 224, a fifth pilot sub-carrier signal is transmitted at a (5,8) point 225, a sixth pilot sub-carrier signal is transmitted at a (6,10) point 226, a seventh pilot sub-carrier signal is transmitted at a (7,3) point 227, and an eighth pilot sub-carrier signal is transmitted at a point (8,6) 228.

As a result, in the first pilot channel, a slope ‘s₁’ is 3 (s₁=3), a frequency offset nⱼ is 0 (nⱼ=0), the total number N of sub-carriers of the OFDM communication system is 11 (N=11). In addition, in the second pilot channel, a slope ‘s₂’ is 3 (s₂=3), a frequency offset nⱼ is 6 (nⱼ=6), the total number N of sub-carriers of the OFDM communication system is 11 (N=11). For a pilot pattern, first pilot channel and the second pilot channel have the same pilot pattern, because the frequency offset nⱼ of the second pilot channel is determined to a next pilot channel of the first pilot channel by the coherence bandwidth 201 and the coherence time 202, and the number Nₚ of pilot channels is 2 (Nₚ=2).

FIG. 3 is a diagram schematically illustrating all possible slopes for a pilot pattern in a conventional OFDM communication system. Referring to FIG. 3, possible slopes for a pilot pattern and the number of the slopes, i.e., possible slopes for transmission of pilot sub-carrier signals and the number of the slopes, are limited according to a coherence bandwidth 201 and a coherence time 202. Assuming that the coherence bandwidth 201 is 6 and the coherence time 202 is 1 as described in connection with FIG. 2, if a slope of a pilot pattern is an integer, there are 6 possible slopes of s=0 (301) to s=5 (306) for a pilot pattern. That is, in this condition, a possible slope for a pilot pattern becomes one of integers 0 to 5. Because the number of possible slopes for a pilot pattern is 6, the number of base stations that can be identified using the pilot pattern in an OFDM communication system satisfying the above condition is 6. In addition, a shaded circle 308 illustrated in FIG. 3 represents a pilot sub-channel signal separated by the coherence bandwidth 201.

All possible slopes for a pilot pattern can be determined by Equation (2).

$${s}_{val} = [ 0 , ⋯ , \frac{{B}_{c} - 1}{{T}_{c}} ] \qquad ( 2 )$$

In Equation (2), sᵥₐₗ denotes possible slopes for a pilot pattern in an OFDM communication system. Although it is preferable that the slopes for a pilot pattern are integers, it is not necessary that the slopes for a pilot pattern should be integers. Further, in Equation (2), T_{c} denotes the number of basic data units constituting a coherence time in the time domain.

In FIG. 3, a basic data unit constituting the coherence time is an OFDM symbol, and thus, the T_{c} represents the number of OFDM symbols. In addition, in Equation (2), B_{c} denotes the number of basic sub-carrier units constituting the coherence bandwidth in the frequency domain.

The maximum number of possible slopes for a pilot pattern is represented by Equation (3).

$${S}_{no\_max} = \frac{{B}_{c}}{{T}_{c}} \qquad ( 3 )$$

In Equation (3), Sₙₒ_{_{—}}ₘₐₓ denotes the maximum number of possible slopes for a pilot pattern in the OFDM communication system.

FIG. 4 is a diagram schematically illustrating an operation in which a pilot pattern generated without considering a coherence bandwidth is estimated incorrectly in a conventional OFDM communication system. However, before a description of FIG. 4 is given, it is assumed that circles illustrated in FIG. 4 represent points where pilot sub-carrier signals are actually transmitted, and transmission points of the pilot sub-carrier signals are expressed in the form of (time domain, frequency domain). Further, it is assumed in FIG. 4 that a coherence bandwidth 201 is 6 in a frequency domain, i.e., the coherence bandwidth 201 has the span of 6 sub-carriers, and a coherence time 202 is 1 in a time domain, i.e., the coherence time 202 is one OFDM symbol. In FIG. 4, two pilot channels, i.e., the first pilot channel and the second pilot channel, are generated without considering the coherence bandwidth 201.

Referring to FIG. 4, a slope s₁ of the first pilot channel is 7 (s₁=7), and the slope s₁=7 of the first pilot channel exceeds a maximum slope 5 of the first pilot channel. Also, a slope s₂ of the second pilot channel is 7 (s₂=7), and the slope s₂=7 of the second pilot channel exceeds the maximum slope 5 of the second pilot channel. When a slope of a pilot channel exceeds a maximum slope of the pilot pattern in this way, the slope of the pilot channel may be estimated incorrectly. A more detailed description thereof will be given below.

For the first pilot channel, a first pilot sub-carrier signal is transmitted at a (1,1) point 411, a second pilot sub-carrier signal is transmitted at a (2,8) point 412, a third pilot sub-carrier signal is transmitted at a (3,4) point 413, a fourth pilot sub-carrier signal is transmitted at a (4,11) point 414, a fifth pilot sub-carrier signal is transmitted at a (5,7) point 415, a sixth pilot sub-carrier signal is transmitted at a (6,3) point 416, a seventh pilot sub-carrier signal is transmitted at a (7,10) point 417, and an eighth pilot sub-carrier signal is transmitted at a point (8,6) 418. For the second pilot channel, a first pilot sub-carrier signal is transmitted at a (1,7) point 421, a second pilot sub-carrier signal is transmitted at a (2,3) point 422, a third pilot sub-carrier signal is transmitted at a (3,10) point 423, a fourth pilot sub-carrier signal is transmitted at a (4,6) point 424, a fifth pilot sub-carrier signal is transmitted at a (5,2) point 425, a sixth pilot sub-carrier signal is transmitted at a (6,9) point 426, a seventh pilot sub-carrier signal is transmitted at a (7,5) point 427, and an eighth pilot sub-carrier signal is transmitted at a point (8,1) 428.

However, because the slope of the first pilot channel and the slope of the second pilot channel both exceed the maximum slope 5, a receiver, or a mobile station, may incorrectly estimate the slope of the first pilot channel and the slope of the second pilot channel.

For example, even though the slope of the first pilot channel is 7, the mobile station estimates the slope of the first pilot channel based on a first pilot signal in the first pilot channel and the second pilot signal in the second pilot channel, thereby incorrectly estimating that the slope of the first pilot channel is 2 (s_{1,wrong}=2). The mobile station incorrectly estimates the slope of the first pilot channel because a slope of the first pilot channel was set to 7 without considering the maximum slope 5 of the first pilot channel, i.e., the coherence bandwidth 201 of 6. Therefore, a pilot signal in another pilot channel, i.e., the second pilot channel, is mistaken for a pilot signal in the first pilot channel. Likewise, even though the slope of the second pilot pattern is 7, the mobile station estimates the slope of the second pilot channel based on a first pilot signal in the second pilot channel and a second pilot signal in the first pilot channel, thereby incorrectly estimating that the slope of the second pilot channel is 1 (s_{2,wrong}=1). The mobile station incorrectly estimates the slope of the second pilot channel because a slope of the second pilot channel was set to 7 without considering the maximum slope 5 of the second pilot channel, i.e., the coherence bandwidth 201 of 6. Therefore, a pilot signal in another pilot channel, i.e., the first pilot channel, is mistaken for a pilot signal in the second pilot channel.

Because a slope of the pilot channel is an integer and limited to a coherence bandwidth, a relationship between a positive slope and a negative slope of the pilot channel is defined as shown in Equation (4).

s⁺=(coherence bandwidth)−s⁻ (4)

In Equation (4), s⁺ denotes a positive slope of a pilot channel, and s⁻ denotes a negative slope of the pilot channel. The positive slope and the negative slope make a pair while satisfying Equation (2).

As described above, in the OFDM scheme, because a pilot pattern used for identifying base stations is limited by a coherence bandwidth and a coherence time, the number of possible pilot patterns is also limited. Therefore, disadvantageously, when the number of base stations is increased, the number of base stations that can be identified with the pilot pattern is limited by the number of possible pilot patterns.

### SUMMARY OF THE INVENTION

It is, therefore, an object of the present invention to provide an apparatus and method for transmitting and receiving a pilot pattern set for identifying base stations in an OFDM communication system.

It is another object of the present invention to provide an apparatus and method for generating a pilot pattern set for identifying base stations in an OFDM communication system.

It is further another object of the present invention to provide an apparatus and method for maximizing a number of pilot patterns for identifying base stations in an OFDM communication system.

In accordance with an aspect of the present invention, there is provided a method of generating base station identification patterns for individually identifying each base station included in a radio communication system, which divides an entire frequency band into a plurality of sub-frequency bands, transmits reference signals at the sub-frequency bands, and transmits data signals at the sub-frequency bands, excluding the sub-frequency bands at which the reference signals are transmitted. The method comprises: dividing a BS identification pattern time interval, which is necessary for identifying the base station identification pattern, into a predetermined number of sub-time intervals; calculating possible reference signal patterns at each of the sub-time intervals considering a predetermined time domain and a predetermined frequency domain; selecting a predetermined number of reference signal patterns among the calculated reference signal patterns at each of the sub-time intervals; and combining the selected reference signal patterns, thereby generating base station identification patterns for identification of the base stations.

In accordance with another aspect of the present invention, there is provided a method for transmitting, by a base station, a base station identification pattern for identifying the base station in a radio communication system that divides an entire frequency band into a plurality of sub-frequency bands, transmits reference signals at the sub-frequency bands, and transmits data signals at the sub-frequency bands, excluding the sub-frequency bands at which the reference signals are transmitted. The method comprises: receiving parallel-converted data signals; generating reference signals corresponding the base station identification pattern; inserting the reference signals into the parallel-converted data signals; IFFT (Inverse Fast Fourier Transform)-converting the parallel-converted data signals into which the reference signals are inserted; serial-converting the IFFT-converted parallel signals; inserting a predetermined guard interval signal into the serial-converted signals; and transmitting the guard interval-inserted signals.

In accordance with further another aspect of the present invention, there is provided a method for receiving, by a mobile station, a base station identification pattern for identifying a base station in a radio communication system that divides an entire frequency band into a plurality of sub-frequency bands, transmits reference signals at the sub-frequency bands, and transmitting data signals at the sub-frequency bands, excluding the sub-frequency bands at which the reference signals are transmitted. The method comprises: removing a guard interval signal from a received signal at a predetermined interval; parallel-converting the guard interval-removed signal; FFT (Fast Fourier Transform)-converting the parallel-converted signal; extracting reference signals from the FFT-converted signals; detecting a base station identification pattern from the extracted reference signals; and identifying the base station to which the mobile station belongs.

In accordance with further another aspect of the present invention, there is provided a method for generating base station identification patterns for individually identifying base stations within cells to which mobile stations belong, in a radio communication system that transmits reference signals from the base station to the mobile stations for identifying the base stations, the method comprising the steps of: dividing a time domain in a frequency-time domain, which is given with a frequency domain and the time domain, into a plurality of sub-time intervals; and determining reference signal patterns at each of the sub-time intervals.

In accordance with further another aspect of the present invention, there is provided an apparatus for generating base station identification patterns for individually identifying base stations included in a radio communication system, which divides an entire frequency band into a plurality of sub-frequency bands, transmits reference signals at the sub-frequency bands, and transmits data signals at the sub-frequency bands, excluding the sub-frequency bands at which the reference signals are transmitted. The apparatus comprises: a reference signal pattern number calculator for dividing a BS identification pattern time interval, which is necessary for identifying the base station identification pattern, into a predetermined number of sub-time intervals, and calculating possible reference signal patterns at each of the sub-time intervals, considering a predetermined time domain and a predetermined frequency domain; and a base station identification pattern determiner for selecting a calculated number of reference signal patterns from the determined reference signal patterns at each of the sub-time intervals and combining the selected reference signal patterns thereby generating base station identification patterns for identification of the base stations.

In accordance with further another aspect of the present invention, there is provided an apparatus for transmitting, by a base station, a base station identification pattern for identifying the base station in a radio communication system that divides an entire frequency band into a plurality of sub-frequency bands, transmits reference signals at the sub-frequency bands, and transmits data signals at the sub-frequency bands, excluding the sub-frequency bands at which the reference signals are transmitted. The apparatus comprises: a base station identification pattern generator for receiving parallel-converted data signals, generating reference signals corresponding the base station identification pattern, and inserting the reference signals into the parallel-converted data signals; an inverse fast Fourier transform (IFFT) unit for IFFT-converting the signals output from the base station identification pattern generator; and a transmitter for serial-converting the IFFT-converted parallel signals, inserting a predetermined guard interval signal into the serial-converted signal, and transmitting the guard interval-inserted signal.

In accordance with further another aspect of the present invention, there is provided an apparatus for receiving, by a mobile station, a base station identification pattern for identifying a base station in a radio communication system that divides an entire frequency band into a plurality of sub-frequency bands, transmits reference signals at the sub-frequency bands, and transmits data signals at the sub-frequency bands, excluding the sub-frequency bands at which the reference signals are transmitted. The apparatus comprises: a receiver for removing a guard interval signal from a received signal at a predetermined interval, and parallel-converting the guard interval-removed signal; a fast Fourier transform (FFT) unit for FFT-converting a signal output from the receiver; a reference signal extractor for extracting reference signals from the FFT-converted signals; and a synchronization and channel estimator for detecting a base station identification pattern from the reference signals extracted from the reference signal extractor, and identifying the base station to which the mobile station belongs.

In accordance with further another aspect of the present invention, there is provided an apparatus for generating base station identification patterns for individually identifying base stations within cells to which mobile stations belong, in a radio communication system that transmits reference signals from the base stations to the mobile stations for identifying the base stations. The apparatus comprises: a reference signal pattern number calculator for dividing a time domain in a frequency-time domain, which is given with a frequency domain and the time domain, into a plurality of sub-time intervals and calculating reference signal patterns determined in a predetermined frequency domain within the frequency domain at each of the sub-time intervals; and a base station identification pattern determiner for selecting a predetermined number of reference signal patterns among the calculated reference signal patterns at each of the sub-time intervals and combining the reference signal patterns selected at each of the sub-time intervals, thereby generating base station identification patterns for identification of the base stations.

### BRIEF DESCRIPTION OF THE DRAWINGS

The above and other objects, features, and advantages of the present invention will become more apparent from the following detailed description when taken in conjunction with the accompanying drawings in which:

FIG. 1 is a diagram schematically illustrating points where pilot sub-carrier signals based on a pilot pattern are transmitted in a conventional OFDM communication system using one pilot channel;

FIG. 2 is a diagram schematically illustrating points where pilot sub-carrier signals based on a pilot pattern are transmitted in a conventional OFDM communication system using two pilot channels;

FIG. 3 is a diagram schematically illustrating all possible slopes for a pilot pattern in a conventional OFDM communication system;

FIG. 4 is a diagram schematically illustrating an operation in which a pilot pattern generated without considering a coherence bandwidth is estimated incorrectly in a conventional OFDM communication system;

FIGS. 5A and 5B are diagrams schematically illustrating points where pilot sub-carrier signals based on a pilot pattern set are transmitted in an OFDM communication system according to an embodiment of the present invention

FIG. 6 is a flowchart illustrating a procedure for assigning a pilot pattern set according to an embodiment of the present invention;

FIG. 7 is a block diagram illustrating an internal structure of an apparatus for assigning a pilot pattern set according to an embodiment of the present invention; and

FIG. 8 is a block diagram schematically illustrating an OFDM communication system for implementing an embodiment of the present invention.

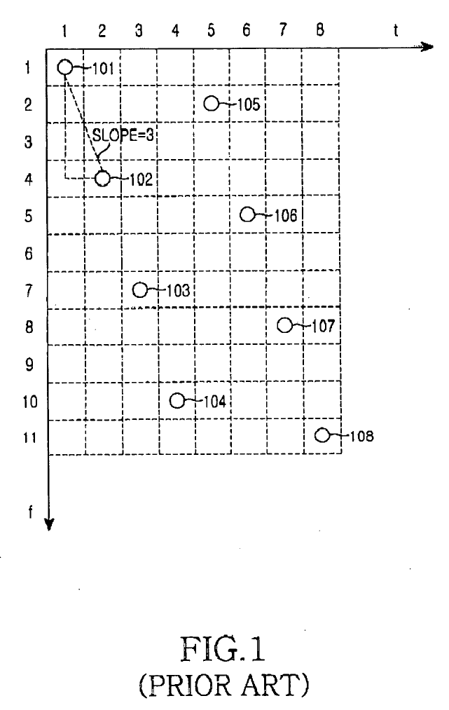

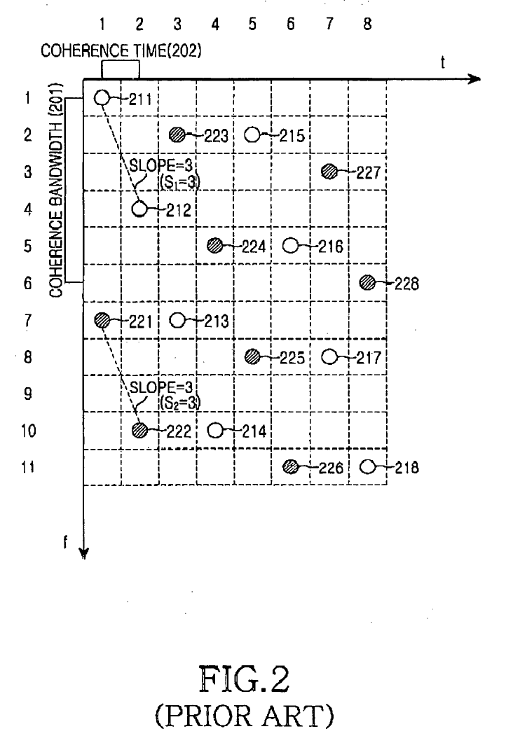

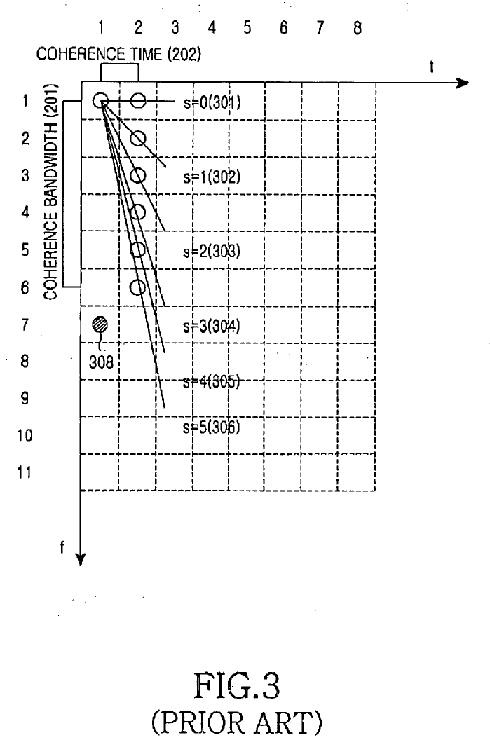

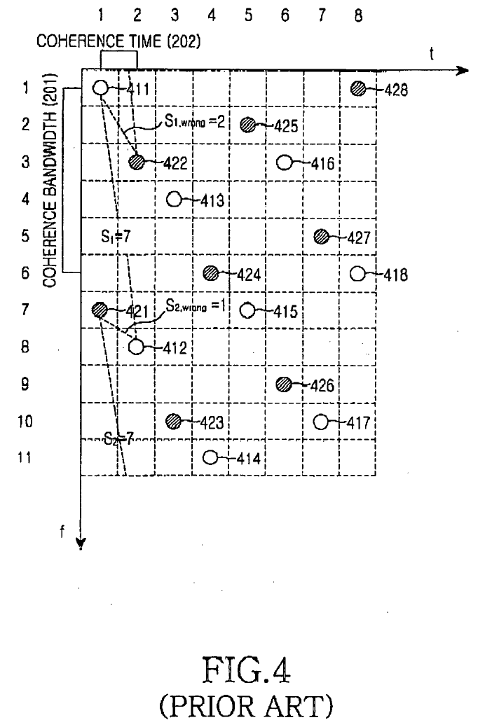

### DETAILED DESCRIPTION OF THE PREFERRED EMBODIMENT

Several preferred embodiments of the present invention will now be described in detail herein below with reference to the annexed drawings. In the following description, a detailed description of known functions and configurations incorporated herein has been omitted for conciseness.

As described above, the present invention provides a method for generating a pilot pattern for identifying a base station (BS) in a communication system utilizing an Orthogonal Frequency Division Multiplexing (OFDM) system, i.e., an OFDM communication system. In particular, the present invention provides a method for generating the pilot pattern by dividing a predetermined time interval, or a pilot pattern set time interval for identifying the pilot pattern, into a plurality of sub-time intervals, thereby maximizing the total number of pilot patterns available in the OFDM communication system.

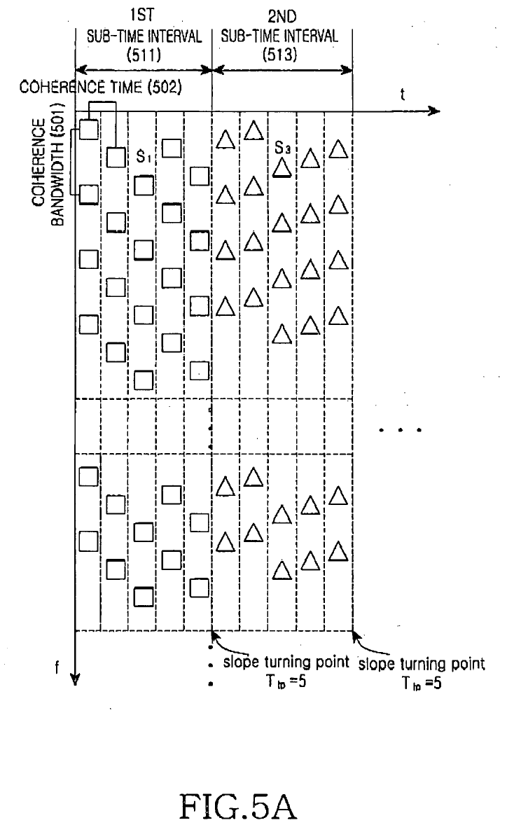

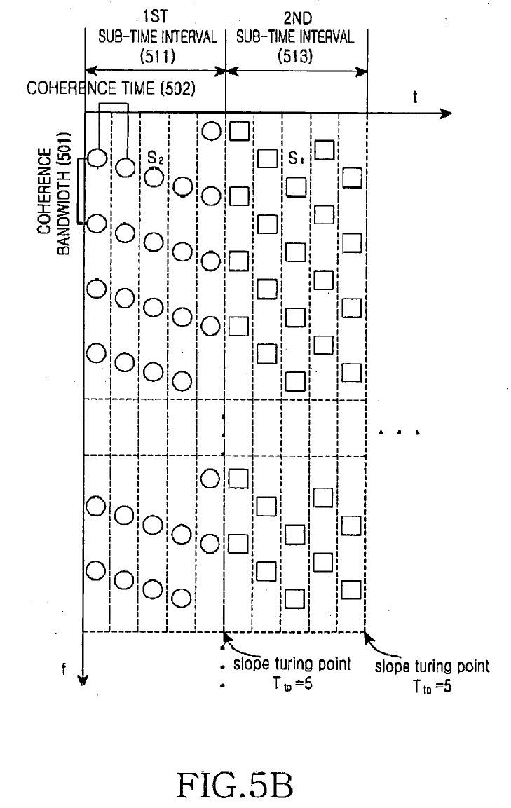

FIGS. 5A and 5B are diagrams schematically illustrating points where pilot sub-carrier signals based on a pilot pattern set are transmitted in an OFDM communication system according to an embodiment of the present invention. However, before a description of FIGS. 5A and 5B is given, it should be noted that in the OFDM communication system, a transmitter, or a base station, transmits pilot sub-carrier signals to a receiver, or a mobile station (MS). The base station transmits data sub-carrier signals (or data channel signals) together with the pilot sub-carrier signals. The pilot sub-carrier signals are transmitted for synchronization acquisition, channel estimation, and base station identification. The pilot sub-carrier signals serve as a type of a training sequence, and are used for performing channel estimation between a transmitter and a receiver.

Further, mobile stations can identify their base stations using the pilot sub-carrier signals. The pilot sub-carrier signals are transmitted at points that have been previously agreed between the transmitter and the receiver. Further, the pilot pattern is a pattern generated by pilot sub-carrier signals transmitted from a base station. That is, the pilot pattern is generated based on a slope of the pilot sub-carrier signals and a transmission start point of the pilot sub-carrier signals.

Therefore, the OFDM communication system should be designed such that base stations have their own unique pilot patterns for their identification. In addition, the pilot pattern is generated in consideration of a coherence bandwidth and a coherence time. The coherence bandwidth represents a maximum bandwidth where it can be assumed that a channel is constant, in a frequency domain. The coherence time represents a maximum time where it can be assumed that a channel is constant, in a time domain.

Because it can be assumed that a channel is constant within the coherence bandwidth and coherence time, even though only one pilot sub-carrier signal is transmitted for the coherence bandwidth and coherence time, it is sufficient for synchronization acquisition, channel estimation, and base station identification. As a result, it is possible to maximize transmission of data channel signals. Therefore, in a common OFDM communication system, a maximum frequency interval for transmitting pilot sub-carrier signals is regarded as a coherence bandwidth, and a maximum time interval, or a maximum OFDM symbol time interval, for transmitting the pilot sub-carrier signals is regarded as a coherence time. The pilot patterns are also limited in number because they are generated considering the coherence bandwidth and the coherence time.

The limitation in number of the pilot patterns causes lack of pilot patterns capable of distinguishing an increasing number of base stations of the OFDM communication system. Therefore, the present invention provides a method for dividing a predetermined time interval, or a BS identification pattern time interval, which is necessary for identification of the pilot pattern, into a plurality of sub-time intervals, and independently generating a pilot pattern at each of the sub-time intervals.

FIG. 5A illustrates points where pilot sub-carrier signals are transmitted according to a pilot pattern set assigned to a first base station (BS1). Referring to FIG. 5A, a predetermined time interval, or a BS identification pattern time interval, which is necessary for identifying the pilot pattern, is divided into a plurality of sub-time intervals, for example, 2 sub-time intervals of a first sub-time interval 511 to a second sub-time interval 513. At each of the first sub-time interval 511 and the second sub-time interval 513, a pilot pattern is generated considering a coherence bandwidth 501 and a coherence time 502.

For the convenience of explanation, it is assumed in FIG. 5A that only one pilot sub-carrier signal is transmitted for the coherence bandwidth 501 and the coherence time 502. However, a plurality of pilot sub-carrier signals can be transmitted for the coherence bandwidth 501 and the coherence time 502. Additionally, although the first sub-time interval 511 and the second sun-time interval 513 are identical in size in FIG. 5A, they can also be different in size.

Herein below, a slope set of pilot patterns used for identifying a base station in the OFDM communication system will be referred to as a “pilot pattern set.” The pilot pattern is a pattern generated by pilot sub-carrier signals transmitted by the base station. That is, the pilot pattern is generated based on a slope of the pilot sub-carrier signals and a transmission start point of the pilot sub-carrier signals. That is, a pilot pattern set is assigned to each of base stations included in the OFDM communication system, and a mobile station identifies a pilot pattern set of its base station among a plurality of pilot pattern sets. That is, the pilot pattern set becomes a type of a base station identification pattern for identifying the base stations.

As described above, the present invention provides a method for generating the pilot pattern by a predetermined time interval, that is, a pilot pattern set time interval, which is necessary for identifying the pilot pattern, into a plurality of sub-time intervals. One pilot pattern is selected from the pilot patterns available at each of the sub-time intervals, and a set of the pilot pattern selected at each sub-time interval is generated into a pilot pattern set. For example, it will be assumed that the number of sub-time interval of pilot pattern set time interval is 2, and each sub-time interval length is the half of a_minimum data transmission interval length. Here, the length of the sub-time interval is assumed to be the half length of the minimum data transmission interval length, to identify the base station by the mobile station, by transmitting the pilot pattern set even though the base station transmits data during a single data transmission time interval. For example, it will be assumed that the minimum data transmission time interval is 10 OFDM symbol interval, therefore, the sub-time interval is 5 OFDM symbol interval.

A pilot pattern of the first sub-time interval 511 has a slope s₁, and a pilot pattern of a second sub-time interval 513 has a slope s₃. As a result, in order to identify the first base station, a mobile station should have information on a slope set of all pilot patterns available in the first base station, i.e., a set [s₁, s₃] of pilot pattern slopes selected at the first sub-time interval 511 and the second sub-time interval 513 among slopes of pilot patterns individually generated at the first sub-time interval 511 and the second sub-time interval 513. Herein, a timing point when the pilot patterns of the pilot pattern set are changed will be referred to as a “slope turning timing point”.

If the slope set of pilot patterns is previously agreed between a transmitter, or the first base station, and a receiver, or a mobile station, the mobile station can identify the first base station. That is, a pilot pattern set is assigned to each of base stations included the OFDM communication system, and a mobile station identifies a pilot pattern set of its base station among a plurality of pilot pattern sets. That is, the pilot pattern set is type of base station identification pattern for identifying the base stations.

The mobile station detects slopes of pilot patterns assigned to the first sub-time interval 511 and the second sub-time interval 513, and detects a pilot pattern set, i.e., a set of slopes of the pilot patterns. The mobile station detects a base station corresponding to the pilot pattern set, and determines the detected base station as its base station, i.e., a first base station.

FIG. 5B illustrates points where pilot sub-carrier signals are transmitted according to a pilot pattern set assigned to a second base station being different from the first base station. Referring to FIG. 5B, as described in FIG. 5A, at each of the sub-time intervals of the first sub-time interval 511 and the second sub-time interval 513, a pilot pattern is generated considering the coherence bandwidth 501 and the coherence time 502. For the convenience of explanation, it is assumed in FIG. 5B that only one pilot sub-carrier signal is transmitted for the coherence bandwidth 501 and the coherence time 502. Alternatively, a plurality of pilot sub-carrier signals can be transmitted for the coherence bandwidth 501 and the coherence time 502. Here, the sub-time interval of FIGS. 5A and 5B are different in selecting one of slopes of pilot patterns generated at the respective sub-time intervals. By generating a pilot pattern set by selecting different slopes for pilot patterns of the respective sub-time intervals, it is possible to identify different base stations.

A pilot pattern of the first sub-time interval 511 has a slope s₂, and a pilot pattern of the second sub-time interval 513 has a slope s₁. As a result, in order to identify the second base station, a mobile station should have information on a slope set of all pilot patterns available in the first base station, i.e., a set [s₂, s₁] of pilot pattern slopes selected at the first sub-time interval 511 and the second sub-time interval 513 among slopes of pilot patterns individually generated at the first sub-time interval 511 and the second sub-time interval 513. If the slope set of pilot patterns is previously agreed between a transmitter, or the second base station, and a receiver, or a mobile station, the mobile station can identify the second base station.

An entire frequency band of the OFDM communication system is divided into p sub-time intervals. At each of the p sub-time intervals, pilot patterns are generated considering a coherence bandwidth and a coherence time. For example, it will be assumed that the number of pilot patterns available at each of the sub-time intervals (i.e., that can be generated at each of the sub-time intervals) is M. One pilot pattern is selected from the M pilot patterns available at each of the sub-time intervals, and a slope set of the pilot pattern selected at each sub-time interval is generated into a pilot pattern set. When the pilot pattern set is generated in this way, the number of possible pilot pattern sets is determined by Equation (5).

number of pilot pattern sets=sₘₐₓ^{p} (5)

In Equation (5), ‘number of pilot pattern sets’ denotes the number of pilot pattern sets available in an OFDM communication system, Sₘₐₓ denotes the maximum number of pilot patterns, i.e., the number of slopes of pilot patterns available at each sub-time interval of the OFDM communication system, and p denotes the number of sub-time intervals of the OFDM communication system. For example, if the maximum number of pilot patterns available at each of the sub-time intervals is 4 (sₘₐₓ=4) and the number of sub-time intervals of the OFDM communication system is 5 (p=5), the total number of base stations that can be identified by the OFDM communication system is 1024 (4⁵=1024).

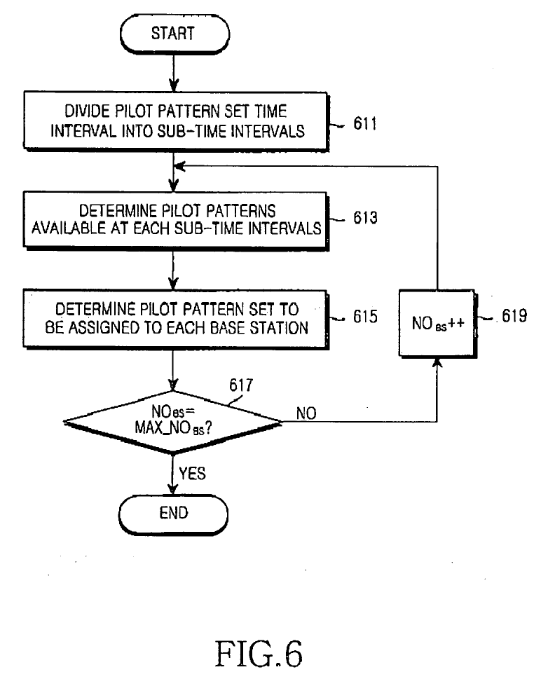

FIG. 6 is a flowchart illustrating a procedure for assigning a pilot pattern set according to an embodiment of the present invention. However, before a description of FIG. 6 is given, it should be noted that a controller (not shown) for an upper layer of an OFDM communication system assigns a pilot pattern set to each of base station included in the OFDM communication system in order to perform the procedure of FIG. 6. Further, the controller notifies each base station of information on a pilot pattern set assigned thereto, and also notifies each mobile station of the same information. Then each base station transmits a pilot signal for base station identification according to the pilot pattern set assigned thereto, and a mobile station determines to which base station it belongs, using a pilot pattern set of the received pilot signal.

Referring to FIG. 6, in step 611, the controller divides a pilot pattern set time interval into a plurality of sub-time intervals. Here, a pilot pattern set time interval length can be variably determined according to a characteristic of the OFDM communication system. Further, the number of sub-time intervals into which the pilot pattern set time interval is divided can be variably determined according to a characteristic of the OFDM communication system.

In step 613, the controller determines pilot patterns available at each of the divided sub-time intervals. As described above, the pilot patterns available at each of the sub-time intervals are determined considering a coherence bandwidth and a coherence time.

In step 615, the controller determines a pilot pattern set to be assigned to each of base stations included in the OFDM communication system. Here, the pilot pattern set is generated by selecting one of the available pilot patterns at each of the sub-time intervals, and as described above, the pilot pattern set refers to a set of pilot patterns selected for each of the sub-time intervals.

In step 617, the controller determines whether the number NO_{BS} of the currently determined pilot pattern sets is identical to the total number MAX_NO_{BS} of base stations included in the OFDM communication system. If it is determined that the number NO_{BS} of the currently determined pilot pattern sets is not identical to the total number MAX_NO_{BS} of base stations included in the OFDM communication system, the controller proceeds to step 619. In step 619, the controller increases the number NO_{BS} of the currently determined pilot pattern sets by 1 (BO_{BS}++), and then returns to step 613. However, if it is determined in step 617 that the number NO_{BS} of the currently determined pilot pattern sets is identical to the total number MAX_NO_{BS} of base stations constituting the OFDM communication system, the controller ends the procedure.

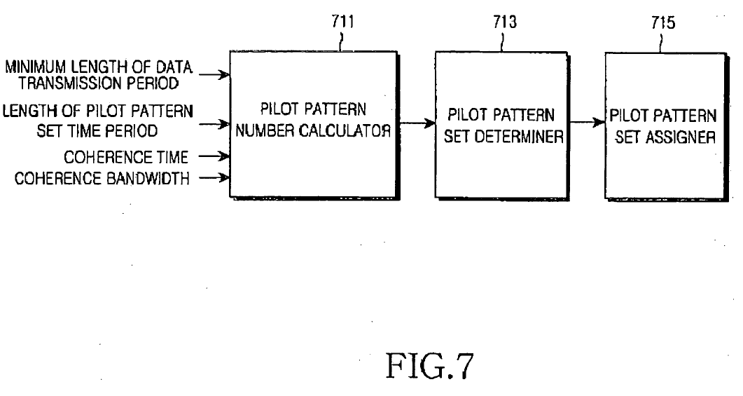

FIG. 7 is a block diagram illustrating an internal structure of an apparatus for assigning a pilot pattern set according to the embodiment of the present invention. Referring to FIG. 7, the pilot pattern set assigning apparatus includes a pilot pattern number calculator 711, a pilot pattern set determiner 713, and a pilot pattern set assigner 715. The pilot pattern number calculator 711 receives information on the number ‘p’ of sub-time intervals into which an pilot pattern set time interval of the OFDM communication system is to be divided, a minimum data transmission time interval length, a pilot pattern set time interval length, a coherence time, and a coherence bandwidth. For example, it is assumed that the number of pilot patterns available at each of the p sub-time intervals is sₘₐₓ. That is, at each of the p sub-time intervals, pilot patterns having slopes [s₁, . . . , sₘₐₓ] of s₁ to sₘₐₓ can be generated.

The pilot pattern number calculator 711 outputs information on the number sₘₐₓ of the pilot patterns available at each of the p sub-time intervals to the pilot pattern set determiner 713. The pilot pattern set determiner 713 receives the information on the number sₘₐₓ of the pilot patterns available at each of the p sub-time intervals, which are output from the pilot pattern number calculator 711, and determines a pilot pattern set by selecting one of the pilot patterns available at each of the p sub-time intervals. Here, the number of the pilot pattern sets is determined based on the number of pilot patterns available at each of the sub-time intervals and the number of sub-time intervals, as described in connection with Equation (5).

The pilot pattern set determiner 713 outputs the determined pilot pattern sets to the pilot pattern set assigner 715. The pilot pattern set assigner 715 receives the pilot pattern sets output from the pilot pattern set determiner 713, and assigns the pilot pattern sets to each of base stations constituting the OFDM communication system.

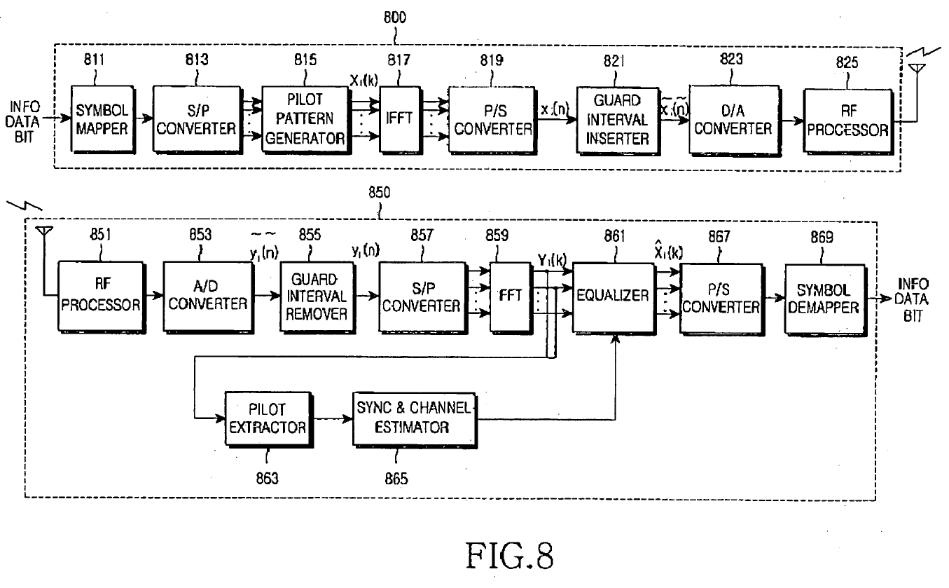

FIG. 8 is a block diagram schematically illustrating an OFDM communication system according to an embodiment of the present invention. Referring to FIG. 8, the OFDM communication system comprises a transmission apparatus, or a base station apparatus 800, and a reception apparatus, or a mobile station apparatus 850. First, the base station apparatus 800 will be described.

The base station apparatus 800 is comprised of a symbol mapper 811, a serial-to-parallel (S/P) converter 813, a pilot pattern generator 815, an inverse fast Fourier transform (IFFT) unit 817, a parallel-to-serial (P/S) converter 819, a guard interval inserter 821, a digital-to-analog (D/A) converter 823, and a radio frequency (RF) processor 825.

When there are information data bits to be transmitted, the information data bits are input to the symbol mapper 811. The symbol mapper 811 symbol-maps (or modulates) the received information data bits using a predetermined modulation scheme, and outputs the symbol-mapped information data bits to the serial-to-parallel converter 813. Here, quadrature phase shift keying (QPSK) or 16-ary quadrature amplitude modulation (16QAM) can be used as the modulation scheme. The serial-to-parallel converter 813 parallel-converts modulated serial symbols output from the symbol mapper 811, and outputs the parallel-converted modulated symbols to the pilot pattern generator 815.

The pilot pattern generator 815 receives the parallel-converted modulated symbols output from the serial-to-parallel converter 813, generates pilot patterns according to a pilot pattern set assigned to the base station itself in the manner described above, inserts the generated pilot patterns into the parallel-converted modulated symbols, and outputs the resultant symbols to the IFFT unit 817. Herein, a signal output from the pilot pattern generator 815, i.e., a parallel signal including the modulated symbols and pilot symbols corresponding to pilot patterns, will be referred to as Xₗ(k). However, an operation for generating pilot patterns according to the pilot pattern set is identical to the operation described in connection with the embodiment of the present invention, therefore a detailed description thereof will be omitted at this time.

The IFFT unit 817 performs N-point IFFT on the signal Xₗ(k) output from the pilot pattern generator 815, and outputs the resultant signal to the parallel-to-serial converter 819. The parallel-to-serial converter 819 serial-converts the signal output from the IFFT unit 817, and outputs the serial-converted signal to the guard interval inserter 821. The signal output from the parallel-to-serial converter 819 is called xₗ(n). The guard interval inserter 821 inserts a guard interval signal into the signal output from the parallel-to-serial converter 819, and outputs the resultant signal to the digital-to-analog converter 823. Here, the guard interval is inserted in order to remove interference between a previous OFDM symbol transmitted at a previous OFDM symbol time and a current OFDM symbol to be transmitted at a current OFDM symbol time in the OFDM communication system.

In addition, the guard interval is used in a Cyclic Prefix scheme for copying last particular samples of an OFDM symbol in a time domain and locating the copied samples in front of a valid OFDM symbol, or a Cyclic Postfix scheme for copying first particular sample of an OFDM symbol in a time domain and locating the copied samples in the tail of a valid OFDM symbol. Further, a signal output from the guard interval inserter 821 will be referred to as \tilde{x}ₗ(ñ), and the signal \tilde{x}ₗ(ñ) output from the guard interval inserter 821 becomes an OFDM symbol.

The digital-to-analog converter 823 analog-converts the signal output from the guard interval inserter 821, and outputs the resultant signal to the RF processor 825. Here, the RF processor 825 includes a filter and a front-end unit. The RF processor 825 RF-processes the signal output from the digital-to-analog converter 823 so that it can be actually transmitted over the air, and transmits the RF-processed signal over the air via an antenna.

11001150 The mobile station apparatus 850 comprises an RF processor 851, an analog-to-digital (A/D) converter 853, a guard interval remover 855, a serial-to-parallel (S/P) converter 857, a fast Fourier transform (FFT) unit 859, an equalizer 861, a pilot extractor 863, a synchronization & channel estimator 865, a parallel-to-serial (P/S) converter 867, and a symbol demapper 869.

A signal transmitted from the base station apparatus 800 passes through a multipath channel and includes a noise component \tilde{w}ₗ(ñ) added thereto, before it is received via an antenna of the mobile station apparatus 850. The signal received via the antenna is input to the RF processor 851, and the RF processor 851 down-coverts the signal received via the antenna into an intermediate frequency (IF) signal, outputs the IF signal to the analog-to-digital converter 853. The analog-to-digital converter 853 digital-converts an analog signal output from the RF processor 851, and outputs the resultant signal to the guard interval remover 855 and the pilot extractor 863. Herein, the digital signal output from the analog-to-digital converter 853 will be referred to as \tilde{y}ₗ(ñ).

The guard interval remover 855 removes a guard interval from the signal \tilde{y}ₗ(ñ) output from the analog-to-digital converter 853, and outputs the resultant signal to the serial-to-parallel converter 857. The signal output from the guard interval remover 855 is yₗ(n). The serial-to-parallel converter 857 parallel-converts the serial signal yₗ(n) output from the guard interval remover 855, and outputs the resultant signal to the FFT unit 859. The FFT unit 859 performs N-point FFT on the signal output from the serial-to-parallel converter 857, and outputs the resultant signal Yₗ(k) to the equalizer 861 and the pilot extractor 863. The equalizer 861 performs channel equalization on the signal Yₗ(k) output from the FFT unit 859, and outputs a resultant signal \hat{X}ₗ(k) to the parallel-to-serial converter 867. The parallel-to-serial converter 867 serial-converts the parallel signal \hat{X}ₗ(k) output from the equalizer 861, and outputs a resultant signal to the symbol demapper 869. The symbol demapper 869 demodulates the signal output from the parallel-to-serial converter 867 using a demodulation scheme corresponding to the modulation scheme used in the base station apparatus 800, and outputs a resultant signal as received information data bits.

Further, the signal Yₗ(k) output from the FFT unit 859 is input to the pilot extractor 863, which extracts pilot symbols from the signal Yₗ(k) output from the FFT unit 859, and outputs the extracted pilot symbols to the synchronization & channel estimator 865. The synchronization & channel estimator 865 performs synchronization and channel estimation on the pilot symbols output from the pilot extractor 863, and outputs the result to the equalizer 861. The synchronization & channel estimator 865, as described above, includes pilot pattern sets for respective base stations included in the OFDM communication system in the form of a table, determines to which pilot pattern set among the pilot pattern sets the pilot patterns output from the pilot extractor 863 matched, and estimates a base station corresponding to the matched pilot pattern set as a base station to which the mobile station apparatus 850 itself belongs. Further, the synchronization & channel estimator 865 should analyze all pilot pattern sets of the OFDM communication system in the same manner.

As can be understood from the description above, a pilot pattern set time interval of an OFDM communication system is divided into a plurality of sub-time intervals. Pilot patterns are generated considering a coherence bandwidth and a coherence time for each of the sub-time intervals, and pilot pattern sets are generated by combining the pilot patterns generated for each sub-time interval. Base stations included in the OFDM communication system are identified with the pilot pattern sets, thereby increasing the number of base stations that can be identified. In conclusion, the limited radio resources, i.e., the limited pilot pattern resources, are grouped for efficient utilization, thereby contributing to improvement in system performance.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for generating base station identification patterns for individually identifying each base station included in a radio communication system, which divides an entire frequency band into a plurality of sub-frequency bands, transmits reference signals at the sub-frequency bands, and transmits data signals at the sub-frequency bands, excluding the sub-frequency bands at which the reference signals are transmitted, the method comprising the steps of:
dividing a BS identification pattern time interval, which is necessary for identifying the base station identification pattern, into a predetermined number of sub-time intervals;
calculating possible reference signal patterns at each of the sub-time intervals considering a predetermined time and a predetermined frequency domain;
selecting a predetermined number of reference signal patterns among the calculated reference signal patterns at each of the sub-time intervals; and
combining the selected reference signal patterns, thereby generating base station identification patterns for identification of the base stations.

2. The method of claim 1, wherein the reference signal pattern is a slope of reference signals transmitted at the sub-frequency bands within the sub-time interval.

3. The method of claim 2, wherein the base station identification pattern is a set of slopes represented by the selected reference signal patterns.

4. The method of claim 1, wherein the predetermined time domain is a maximum time domain in which a radio channel environment is constant, and the predetermined frequency domain is a maximum frequency domain in which the radio channel environment is constant.

5. An apparatus for generating base station identification patterns for individually identifying base stations included in a radio communication system, which divides an entire frequency band into a plurality of sub-frequency bands, transmits reference signals at the sub-frequency bands, and transmits data signals at the sub-frequency bands, excluding the sub-frequency bands at which the reference signals are transmitted, the apparatus comprising:
a reference signal pattern number calculator for dividing a BS identification pattern time interval, which is necessary for identifying the base station identification pattern, into a predetermined number of sub-time intervals, and calculating possible reference signal patterns at each of the sub-time intervals, considering a predetermined time domain and a predetermined frequency domain; and
a base station identification pattern determiner for selecting a calculated number of reference signal patterns from the determined reference signal patterns at each of the sub-time intervals and combining the selected reference signal patterns thereby generating base station identification patterns for identification of the base stations.

6. The apparatus of claim 5, further comprising a base station identification pattern assigner for assigning the determined base station identification patterns to their corresponding base stations.

7. The apparatus of claim 5, wherein the reference signal pattern is a slope of reference signals transmitted at the sub-frequency bands within the sub-time interval.

8. The apparatus of claim 7, wherein the base station identification pattern is a set of slopes represented by the selected reference signal patterns.

9. The apparatus of claim 5, wherein the predetermined time domain is a maximum time domain in which a radio channel environment is constant, and the predetermined frequency domain is a maximum frequency domain in which the radio channel environment is constant.

10. An apparatus for transmitting, by a base station, a base station identification pattern for identifying the base station in a radio communication system that divides an entire frequency band into a plurality of sub-frequency bands, transmits reference signals at the sub-frequency bands, and transmits data signals at the sub-frequency bands, excluding the sub-frequency bands at which the reference signals are transmitted, the apparatus comprising:
a base station identification pattern generator for receiving parallel-converted data signals, generating reference signals corresponding the base station identification pattern, and inserting the reference signals into the parallel-converted data signals;
an inverse fast Fourier transform (IFFT) unit for IFFT-converting the signals output from the base station identification pattern generator; and
a transmitter for serial-converting the IFFT-converted parallel signals, inserting a predetermined guard interval signal into the serial-converted signal, and transmitting the guard interval-inserted signal.

11. The apparatus of claim 10, wherein the transmitter comprises:
a parallel-to-serial converter for serial-converting the IFFT-converted parallel signals;
a guard interval inserter for inserting the guard interval signal into a serial signal output from the parallel-to-serial converter; and
a radio frequency (RF) processor for RF-processing a signal output from the guard interval inserter.

12. The apparatus of claim 10, wherein the base station identification pattern is generated by dividing a BS identification pattern time interval, which is necessary for identifying the base station identification pattern, into a predetermined number of sub-time intervals, selecting a predetermined number of reference signal patterns among possible reference signals at each of the sub-time intervals, considering a predetermined time domain and a predetermined frequency domain, and combining the reference signal patterns selected at each of the sub-time intervals.

13. The apparatus of claim 12, wherein the reference signal pattern is a slope of reference signals transmitted at the sub-frequency bands within the sub-time interval.

14. The apparatus of claim 13, wherein the base station identification pattern is a set of slopes represented by the selected reference signal patterns.

15. The apparatus of claim 12, wherein the predetermined time domain is a maximum time domain in which a radio channel environment is constant, and the predetermined frequency domain is a maximum frequency domain in which the radio channel environment is constant.

16. A method for transmitting, by a base station, a base station identification pattern for identifying the base station in a radio communication system that divides an entire frequency band into a plurality of sub-frequency bands, transmits reference signals at the sub-frequency bands, and transmits data signals at the sub-frequency bands, excluding the sub-frequency bands at which the reference signals are transmitted, the method comprising the steps of:
receiving parallel-converted data signals; generating reference signals corresponding the base station identification pattern;
inserting the reference signals into the parallel-converted data signals;
IFFT (Inverse Fast Fourier Transform)-converting the parallel-converted data signals into which the reference signals are inserted;
serial-converting the IFFT-converted parallel signals;
inserting a predetermined guard interval signal into the serial-converted signals; and
transmitting the guard interval-inserted signals.

17. The method of claim 16, wherein the base station identification pattern is generated by dividing a BS identification pattern time interval, which is necessary for identifying the base station identification pattern, into a predetermined number of sub-time intervals, selecting a predetermined number of reference signal patterns among possible reference signals at each of the sub-time intervals, considering a predetermined time domain and a predetermined frequency domain, and combining the reference signal patterns selected at each of the sub-time intervals.

18. The method of claim 17, wherein the reference signal pattern is a slope of reference signals transmitted at the sub-frequency bands within the sub-time interval.

19. The method of claim 18, wherein the base station identification pattern is a set of slopes represented by the selected reference signal patterns.

20. The method of claim 17, wherein the predetermined time domain is a maximum time domain in which a radio channel environment is constant, and the predetermined frequency domain is a maximum frequency domain in which the radio channel environment is constant.

21. An apparatus for receiving, by a mobile station, a base station identification pattern for identifying a base station in a radio communication system that divides an entire frequency band into a plurality of sub-frequency bands, transmits reference signals at the sub-frequency bands, and transmits data signals at the sub-frequency bands, excluding the sub-frequency bands at which the reference signals are transmitted, the apparatus comprising:
a receiver for removing a guard interval signal from a received signal at a predetermined interval, and parallel-converting the guard interval-removed signal;
a fast Fourier transform (FFT) unit for FFT-converting a signal output from the receiver;
a reference signal extractor for extracting reference signals from the FFT-converted signals; and
a synchronization and channel estimator for detecting a base station identification pattern from the reference signals extracted from the reference signal extractor, and identifying the base station to which the mobile station belongs.

22. The apparatus of claim 21, wherein the receiver comprises:
a guard interval remover for removing the guard interval signal from the received signal; and
a serial-to-parallel converter for parallel-converting the guard interval-removed serial signal.

23. The apparatus of claim 21, wherein the base station identification pattern is generated by dividing a BS identification pattern time interval, which is necessary for identifying the base station identification pattern, into a predetermined number of sub-time intervals, selecting a predetermined number of reference signal patterns among possible reference signals at each of the sub-time intervals, considering a predetermined time domain and a predetermined frequency domain, and combining the reference signal patterns selected at each of the sub-time intervals.

24. The apparatus of claim 23, wherein the reference signal pattern is a slope of reference signals transmitted at the sub-frequency bands within the sub-time interval.

25. The apparatus of claim 24, wherein the base station identification pattern is a set of slopes represented by the selected reference signal patterns.

26. The apparatus of claim 23, wherein the predetermined time domain is a maximum time domain in which a radio channel environment is constant, and the predetermined frequency domain is a maximum frequency domain in which the radio channel environment is constant.

27. A method for receiving, by a mobile station, a base station identification pattern for identifying a base station in a radio communication system that divides an entire frequency band into a plurality of sub-frequency bands, transmits reference signals at the sub-frequency bands, and transmitting data signals at the sub-frequency bands, excluding the sub-frequency bands at which the reference signals are transmitted, the method comprising the steps of:
removing a guard interval signal from a received signal at a predetermined interval;
parallel-converting the guard interval-removed signal;
FFT (Fast Fourier Transform)-converting the parallel-converted signal;
extracting reference signals from the FFT-converted signals;
detecting a base station identification pattern from the extracted reference signals; and
identifying the base station to which the mobile station belongs.

28. The method of claim 27, wherein the base station identification pattern is generated by dividing a BS identification pattern time interval, which is necessary for identification of the base station identification pattern, into a predetermined number of sub-time intervals, selecting a predetermined number of reference signal patterns among possible reference signals at each of the sub-time intervals, while considering a predetermined time domain and a predetermined frequency domain, and combining the reference signal patterns selected at each of the sub-time intervals.

29. The method of claim 28, wherein the reference signal pattern is a slope of reference signals transmitted at the sub-frequency bands within the sub-time interval.

30. The method of claim 29, wherein the base station identification pattern is a set of slopes represented by the selected reference signal patterns.

31. The method of claim 28, wherein the predetermined time domain is a maximum time domain in which a radio channel environment is constant, and the predetermined frequency domain is a maximum frequency domain in which the radio channel environment is constant.

32. A method for generating base station identification patterns for individually identifying base stations within cells to which mobile stations belong, in a radio communication system that transmits reference signals from the base station to the mobile stations for identifying the base stations, the method comprising the steps of:
dividing a time domain in a frequency-time domain, which is given with a frequency domain and the time domain, into a plurality of sub-time intervals; and
determining reference signal patterns at each of the sub-time intervals.

33. The method of claim 32, wherein the time domain is divided into the plurality of time intervals, such that each of the plurality of sub-time intervals has at least one of predetermined time domains.

34. The method of claim 32,wherein each of the predetermined time domains corresponds to a maximum time domain in which a radio channel environment is constant.

35. The method of claim 32, wherein the reference signal pattern is a slope of reference signals transmitted in the predetermined frequency domain within the sub-rime intervals.

36. An apparatus for generating base station identification patterns for individually identifying base stations within cells to which mobile stations belong, in a radio communication system that transmits reference signals from the base stations to the mobile stations for identifying the base stations, the apparatus comprising:
a reference signal pattern number calculator for dividing a time domain in a frequency-time domain, which is given with a frequency domain and the time domain, into a plurality of sub-time intervals and calculating reference signal patterns determined in a predetermined frequency domain within the frequency domain at each of the sub-time intervals; and
a base station identification pattern determiner for selecting a predetermined number of reference signal patterns among the calculated reference signal patterns at each of the sub-time intervals and combining the reference signal patterns selected at each of the sub-time intervals, thereby generating base station identification patterns for identification of the base stations.

37. The apparatus of claim 36, wherein the time domain is divided into the plurality of time intervals, such that each of the plurality of sub-time intervals has at least one of predetermined time domains 38. The apparatus of claim 36, wherein each of the predetermined time domains corresponds to a maximum time domain in which a radio channel environment is constant.

38. The apparatus of claim 36, wherein the reference signal pattern is a slope of reference signals transmitted in the predetermined frequency domain within the sub-rime intervals.

39. The apparatus of claim 38, wherein the base station identification pattern is a set of slopes represented by the selected reference signal patterns reference signals are constant.
